(19) United States
(12) Patent Application Publication
(10) Pub. No.: US 2026/0321184 A1
(43) Pub. Date: Oct. 15, 2026

(54) DISPLAY DEVICE

(71) Applicant: Sharp Display Technology Corporation, Kameyama City, Mie (JP)

(72) Inventor: Masashi MAYUMI, Kameyama City (JP)

(21) Appl. No.: 19/484,417

(22) PCT Filed: May 19, 2023
(86) PCT No.: PCT/JP2023/018748

§ 371 Date: Nov. 14, 2025

(51) Int. Cl. G09G 3/20; G06F 3/041

(52) U.S. Cl. CPC G09G 3/2096; G06F 3/04164; G06F 3/04182; G09G 2310/0267; G09G 2310/0286

(57) ABSTRACT

A display device includes: a clock signal output circuit: a plurality of clock signal lines; a driver circuit including a shift register and electrically connected to the plurality of clock signal lines; a plurality of pixel circuits; and a first time-constant circuit connected between the clock signal output circuit and the plurality of clock signal lines.

### TECHNICAL FIELD

The present disclosure relates to a display device.

### BACKGROUND ART

Patent Document 1 discloses a technique for reducing false detection of a touch sensor by calculating noise generated in a display device.

### CITATION LIST

### Patent Literature

[Patent Document 1] Japanese Unexamined Patent Application Publication No. 2020-119232

### SUMMARY

### Technical Problem

The technique described in Patent Document 1 could fail to reduce false detection of the touch sensor.

### Solution to Problem

A display device according to an aspect of the present disclosure includes: a clock signal output circuit: a plurality of clock signal lines; a driver circuit including a shift register and electrically connected to the plurality of clock signal lines; a plurality of pixel circuits; and at least one of a first time-constant circuit connected between the clock signal output circuit and the plurality of clock signal lines or a second time-constant circuit connected between the driver circuit and the plurality of pixel circuits.

### Advantageous Effect of Disclosure

An aspect of the present disclosure reduces noise around a driver circuit, thereby successfully reducing false detection of a touch sensor because of the noise.

### BRIEF DESCRIPTION OF DRAWINGS

FIG. 1 illustrates a schematic diagram showing a configuration of a display device according to an embodiment.

FIG. 2 illustrates a waveform chart showing behavior of a time-constant circuit.

FIG. 3 illustrates waveform charts showing an advantageous effect of the time-constant circuit.

FIG. 4 illustrates a schematic diagram showing a configuration of a first time-constant circuit.

FIG. 5 illustrates a cross-sectional view showing a configuration of the display device according to the embodiment.

FIG. 6 illustrates a cross-sectional view showing a configuration of a touch sensor layer.

FIG. 7 illustrates a plan view showing a configuration of the touch sensor layer.

FIG. 8 illustrates a circuit diagram showing an exemplary configuration of a subpixel of the display device.

FIG. 9 illustrates a circuit diagram showing a configuration (a unit stage) of a shift register in a first driver.

FIG. 10 illustrates a circuit diagram showing a configuration (a unit stage) of a shift register in a second driver.

FIG. 11 illustrates a circuit diagram showing a configuration (a unit stage) of a shift register in a third driver.

FIG. 12 illustrates a timing diagram showing waveforms of clock signals and drive signals of the display device according to the embodiment.

FIG. 13 illustrates a schematic diagram showing a configuration of a display device according to a comparative example.

FIG. 14 illustrates a timing diagram showing clock signals and drive signals (scan signals and discharge control signals) of the comparative example.

FIG. 15 illustrates a timing diagram showing clock signals and drive signals (light-emission control signals) of the comparative example.

FIG. 16 illustrates graphs showing noise generated in the comparative example and the embodiment.

FIG. 17 illustrates a schematic diagram showing another configuration of the display device according to the embodiment.

FIG. 18 illustrates a schematic diagram showing another configuration of the display device according to the embodiment.

FIG. 19 illustrates a schematic diagram showing another configuration of the display device according to the embodiment.

FIG. 20 illustrates an exemplary second time-constant circuit in FIG. 19.

FIG. 21 illustrates a schematic diagram showing another configuration of the display device according to the embodiment.

FIG. 22 illustrates a schematic diagram showing another configuration of the display device according to the embodiment.

FIG. 23 illustrates a timing diagram showing clock signals according to another embodiment.

FIG. 24 is a timing diagram showing a portion of FIG. 23 under magnification.

FIG. 25 illustrates graphs showing a noise reducing effect according to the configuration in FIG. 22.

FIG. 26 illustrates a timing diagram showing clock signals according to another embodiment.

### DESCRIPTION OF EMBODIMENTS

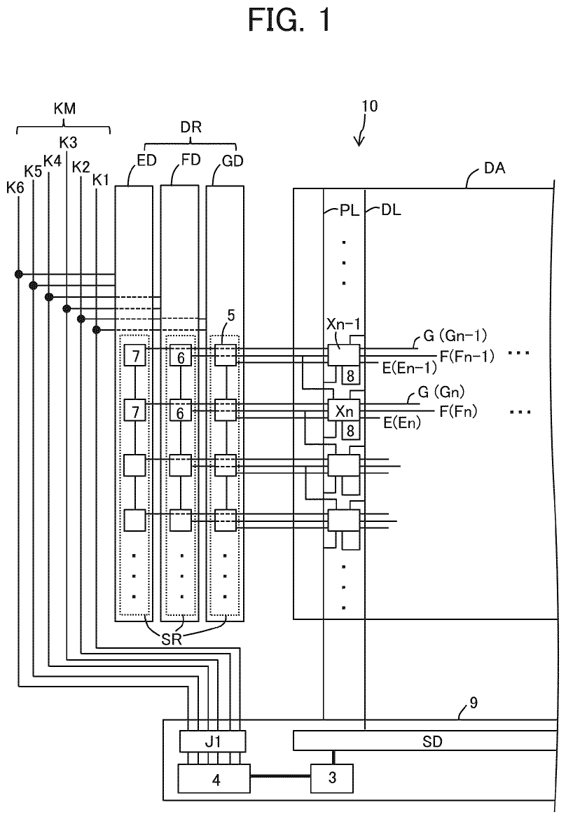

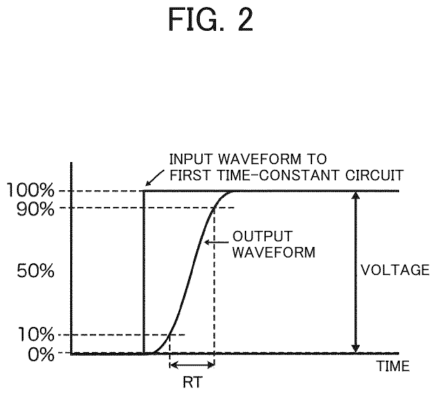

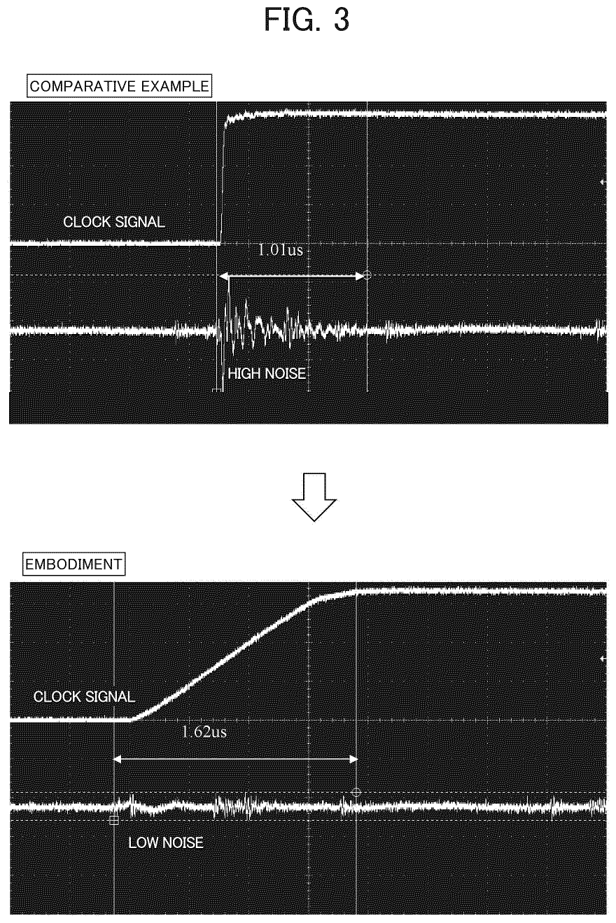

FIG. 1 illustrates a schematic diagram showing a configuration of a display device according to an embodiment. FIG. 2 illustrates a waveform chart showing behavior of a time-constant circuit. FIG. 3 illustrates waveform charts showing an advantageous effect of the time-constant circuit. As illustrated in FIG. 1, a display device 10 according a first embodiment includes: a clock signal output circuit 4; a plurality of clock signal lines K1 to K6; a driver circuit DR including a shift register SR and electrically connected to the plurality of clock signal lines K1 to K6; a plurality of pixel circuits Xn-1 and Xn; and a first time-constant circuit J1 connected between the clock signal output circuit 4 and the plurality of clock signal lines K1 to K6.

As illustrated in FIG. 2, the first time-constant circuit J1 distorts a waveform of each of a plurality of clock signals to be input from the clock signal output circuit 4 (that is, the first time-constant circuit J1 increases a time constant in a rise and a fall). Such a feature reduces noise around the driver circuit DR (e.g., noise generated from the plurality of clock signal lines K1 to K6), thereby successfully reducing false detection of a touch sensor when the display device 10 is provided with a touch sensor layer. FIG. 3 shows that, when a rising waveform of a clock signal is distorted, an amplitude of ringing noise is significantly reduced.

The first time-constant circuit J1 increases, for example, a rise period RT (a time period required to reach from 10% to 90% of a pulse amplitude) and a fall period FT (a time required to reach from 90% to 10% of a pulse amplitude) of each of the clock signals to be input.

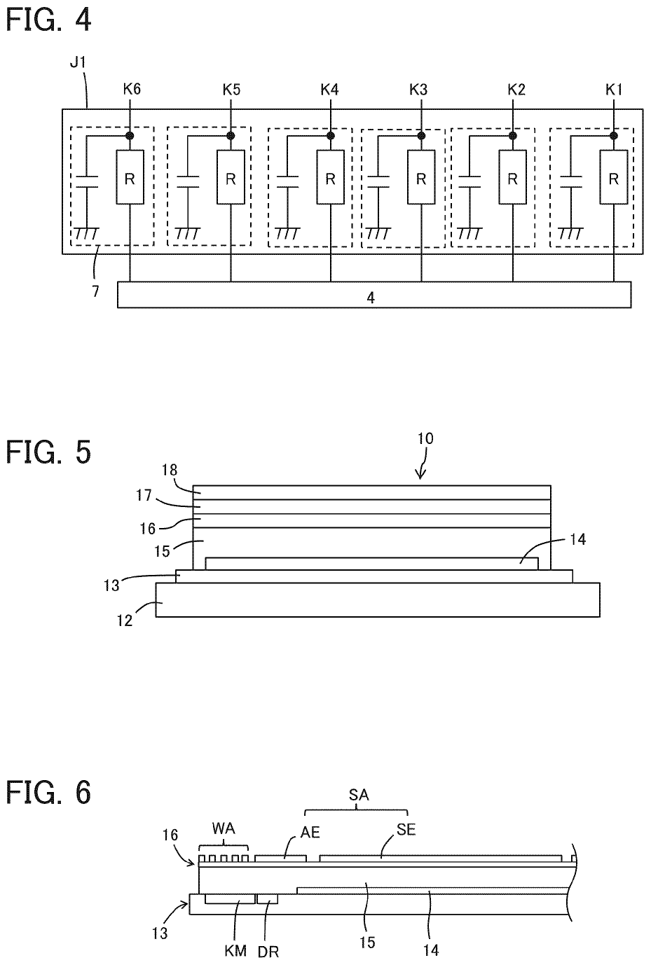

FIG. 4 illustrates a schematic diagram showing a configuration of the first time-constant circuit. As illustrated in FIG. 4, the first time-constant circuit J1 may include as many CR circuits 7 as input systems, and each of the CR circuits 7 may have a resistor and a capacitance connected in parallel with each other. The first time-constant circuit J1 may distort a waveform of each of the clock signals provided in six systems and input from the clock signal output circuit 4 and may output the clock signals to the plurality of clock signal lines K1 to K6. The display device 10 may include a control board 9 including a timing controller 3 and the clock signal output circuit 4, and the first time-constant circuit J1 may be provided to the control board 9. The clock signal output circuit 4 may be a level shifter IC.

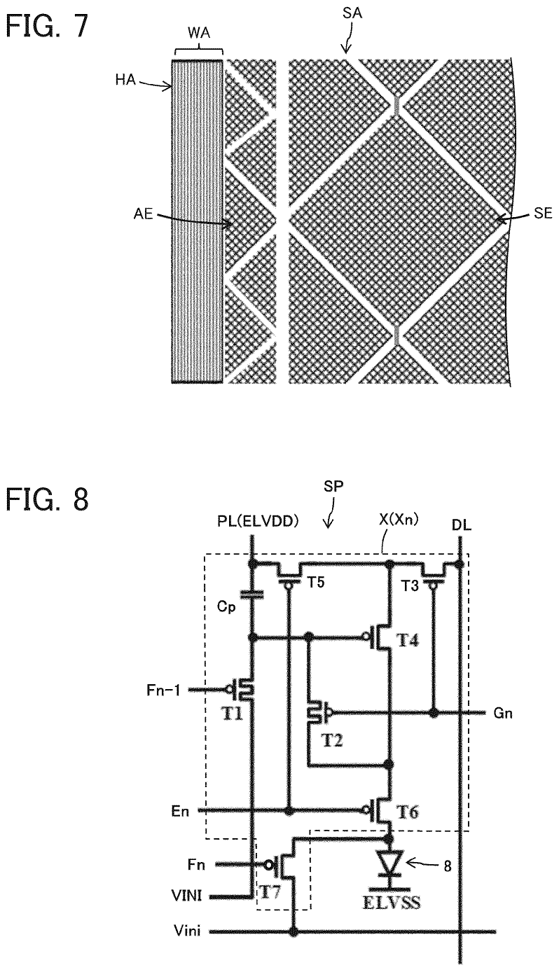

FIG. 5 illustrates a cross-sectional view showing a configuration of the display device according to the embodiment. FIG. 6 illustrates a cross-sectional view showing a configuration of the touch sensor layer. FIG. 7 illustrates a plan view showing a configuration of the touch sensor layer. As illustrated in FIG. 5, the display device 10 includes: a main substrate 12; a pixel circuit layer 13, a light-emitting-element layer 14 including, for example, a plurality of light-emitting diodes (LEDs); a sealing layer 15; a touch sensor layer 16; an optical layer 17; and a protective layer 18. A clock signal line group KM including the clock signal lines K1 to K6, the driver circuit DR, and the pixel circuits Xn-1 and X illustrated in FIG. 1 are formed in the pixel circuit layer 13.

In the embodiment, the LEDs used for the display device 10 are, for example, organic LEDs (OLEDs). Alternatively, the LEDs may be quantum-dot LEDs or inorganic crystal LEDs. The display device 10 shall not be limited to an LED display device, and may be, for example, a liquid crystal display device.

As illustrated in FIGS. 6 and 7, the touch sensor layer 16 may have: a sensor electrode group SA (including a sensor electrode SE and a peripheral electrode AE); and a routed wire group HA electrically connected to the sensor electrode group SA. The touch sensor layer 16 includes a routing region WA (a region in which the routed wire group HA is formed) positioned near an edge of the touch sensor layer 16. In a plan view, the routing region WA may overlap with the clock signal line group KM (the plurality of clock signal lines K1 to K6). In such a configuration, the noise generated from the clock signal line group KM is likely to affect accuracy of a sensor in the touch sensor layer 16. Accordingly, the first time-constant circuit J1 has a great advantage in reducing the noise. The configuration is also suitable for use with an active stylus pen (a touch pen for exchanging information with the display device 10 having a touch sensor). The configuration is also suitable for a display device including a sensor for sensing, for example, movement of an approaching object (in a non-contact manner).

As illustrated in FIG. 1, the display device 10 may include: a plurality of scan signal lines G; a plurality of discharge control lines F; a plurality of light-emission control lines E; a plurality of data signal lines DL; and a plurality of pixel power supply lines PL, all of which run in a display unit DA. The driver circuit DR may include: a first driver GD (a gate driver) including a shift register SR; a second driver FD (a discharge control driver) including a shift register SR; and a third driver ED (a light-emission control driver) including a shift register SR. The first driver GD outputs drive signals (scan signals) to the plurality of scan signal lines G. The second driver FD outputs drive signals (discharge control signals) to the plurality of discharge control lines F. The third driver ED outputs drive signals (light-emission control signals) to the plurality of light-emission control lines E. A source driver SD provided to the control board 9 outputs data signals to the data signal lines DL.

The first clock signal line K1 and the second clock signal line K2 may be connected to the first driver GD, the third clock signal line K3 and the fourth clock signal line K4 may be connected to the second driver FD, and the fifth clock signal line K5 and the sixth clock signal line K6 may be connected to the third driver ED. The clock signal line group KM and the driver circuit DR can be formed outside the display unit DA (i.e., a picture-frame unit).

FIG. 8 illustrates a circuit diagram showing an exemplary configuration of a subpixel of the display device. As illustrated in FIGS. 1 and 8, the display unit DA is provided with a subpixel SP including: a pixel circuit X; and a light-emitting element 8. For example, the pixel circuit Xn (a pixel circuit X in an n-th stage) includes: a pixel capacitor Cp; an initialization transistor T1; a threshold value compensation transistor T2; a write control transistor T3; a drive transistor T4; a power supply control transistor T5; a light-emission control transistor T6; and a discharge transistor T7. The transistors T1 to T7 may be p-type transistors.

The initialization transistor T1 has a gate terminal connected to a discharge control line Fn-1 in an n-1-th stage. Each of the threshold value compensation transistor T2 and the write control transistor T3 has a gate terminal connected to a scan signal line Gn in an n-th stage. The light-emission control transistor T6 has a gate terminal connected to a light-emission control line En in the n-th stage. The discharge transistor T7 has a gate terminal connected to a discharge control line Fn in the n-th stage. The drive transistor T4 has a gate terminal connected to the pixel power supply line PL (an ELVDD wire) through the pixel capacitor Cp, and to a first initialization line VINI through the initialization transistor T1.

The drive transistor T4 has a source terminal connected to a data signal line DL through the write control transistor T3, and to the pixel power supply line PL through the power supply control transistor T5. The drive transistor T4 has a drain terminal connected to an anode of the light-emitting element 8 through the light-emission control transistor T6, and to the gate terminal of the drive transistor T4 through the threshold value compensation transistor T2. The anode of the light-emitting element 8 is connected to a second initialization line Vini through the discharge transistor T7.

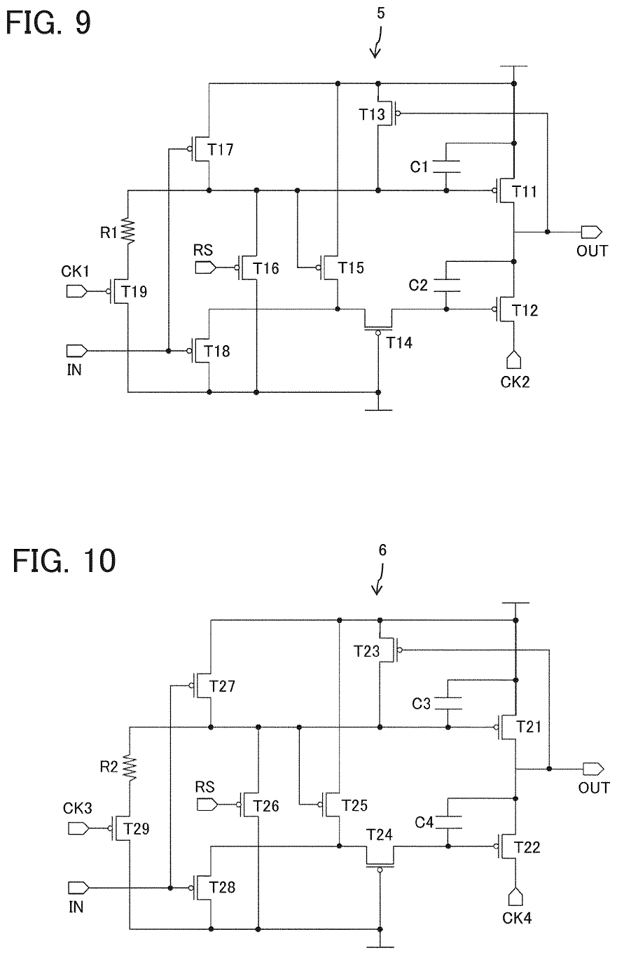

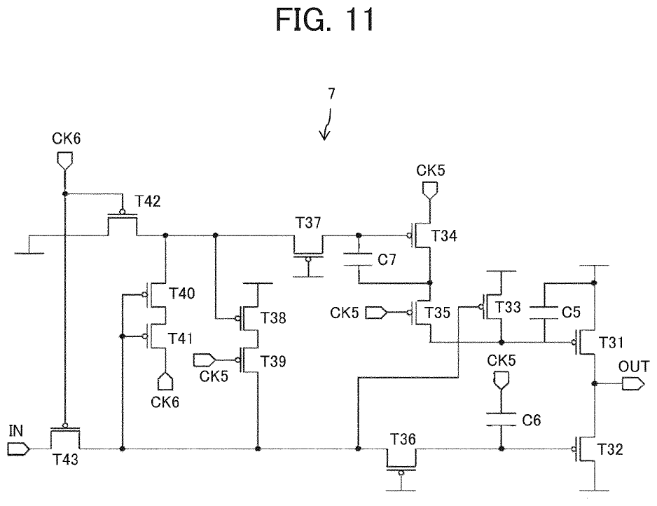

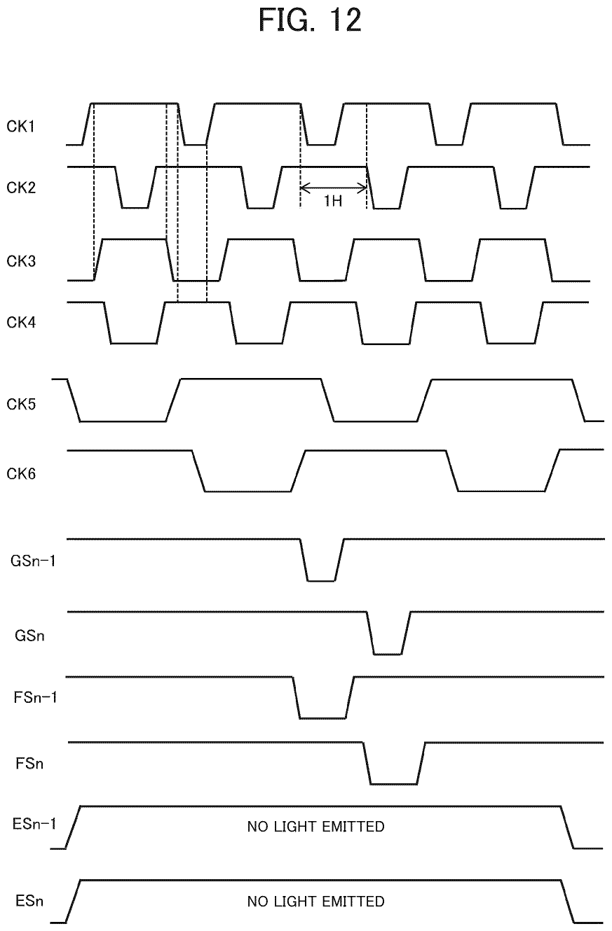

FIG. 9 illustrates a circuit diagram showing a configuration (a unit stage) of a shift register in a first driver. FIG. 10 illustrates a circuit diagram showing a configuration (a unit stage) of a shift register in a second driver. FIG. 11 illustrates a circuit diagram showing a configuration (a unit stage) of a shift register in a third driver. In FIG. 1, the clock signal line K1 is supplied with a first clock signal line CK1, the clock signal line K2 is supplied with a second clock signal CK2, the clock signal line K3 is supplied with a third clock signal CK3, the clock signal line K4 is supplied with a fourth clock signal CK4, the clock signal line K5 is supplied with a fifth clock signal CK5, and the clock signal line K6 is supplied with a sixth clock signal CK6.

The shift register SR of the first driver GD includes a plurality of unit circuits 5. As illustrated in FIG. 9, a unit stage 5 includes: p-type transistors T11 to T19; a resistor R1; and capacitors C1 and C2. The unit circuit 5 has: an input terminal IN serving as a gate terminal of the transistor T18; an output terminal OUT serving as a gate terminal of the transistor T13; and a reset terminal RS serving as a gate terminal of the transistor T16. The first clock signal CK1 is input to a gate terminal of the transistor T19, and the second clock signal CK2 is input to a drain terminal of the transistor T12.

The shift register SR of the second driver FD includes a plurality of unit circuits 6. As illustrated in FIG. 10, a unit stage 6 includes: p-type transistors T21 to T29; a resistor R2; and capacitors C3 and C4. The unit circuit 6 has: an input terminal IN serving as a gate terminal of the transistor T28; an output terminal OUT serving as a gate terminal of the transistor T23; and a reset terminal RS serving as a gate terminal of the transistor T26. The third clock signal CK3 is input to a gate terminal of the transistor T29, and the fourth clock signal CK4 is input to a drain terminal of the transistor T22.

The shift register SR of the third driver ED includes a plurality of unit circuits 7. As illustrated in FIG. 11, a unit stage 7 includes: p-type transistors T31 to T43; and capacitors C5 to C7. The unit circuit 7 has: an input terminal IN serving as a source terminal of the transistor T43; and an output terminal OUT serving as a drain terminal of the transistor T31. The fifth clock signal CK5 is input to a source terminal of the transistor T34, to a gate terminal of the transistor T35, to a gate terminal of the transistor T39, and to one of electrodes of the capacitor C6. The sixth clock signal CK6 is input to a gate terminal of the transistor T43 and to a source terminal of the transistor T41.

FIG. 12 illustrates a timing diagram showing waveforms of clock signals and drive signals of the display device according to the embodiment. Here, GSn-1 and GSn denote drive signals (scan signals) of respective scan signal lines Gn-1 and Gn, FSn-1 and FSn denote drive signals (discharge control signals) of respective discharge control lines Fn-1 and Fn, and ESn 1 and ESn denote drive signals (light-emission control signals) of respective light-emission control lines En-1 and En.

As shown in FIG. 12, the first time-constant circuit J1 distorts waveforms (pulse waveforms) of the respective first clock signal CK1 to sixth clock signal CK6, thereby successfully reducing noise around the driver circuit DR.

Furthermore, the first clock signal CK1 and the third clock signal CK3 are made different in pulse width so as not to rise or fall synchronously, and the second clock signal CK2 and the fourth clock signal CK4 are made different in pulse width so as not to rise or fall synchronously. Such a feature can further reduce the noise.

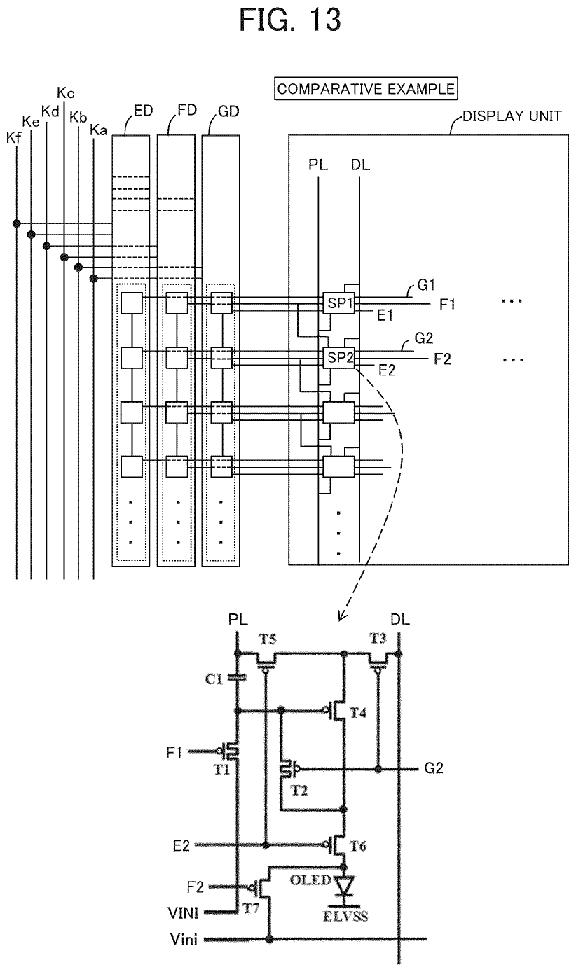

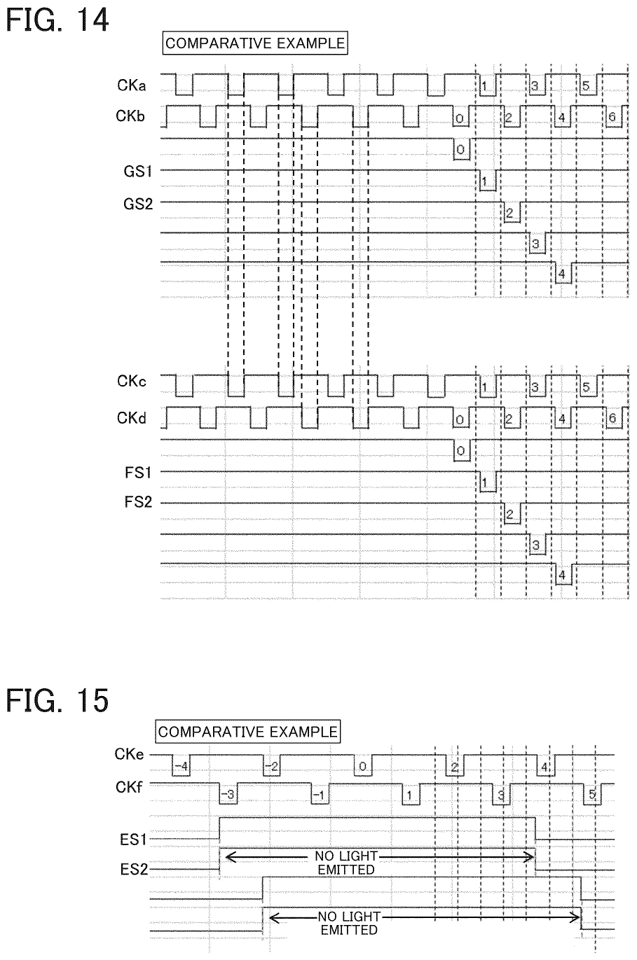

FIG. 13 illustrates a schematic diagram showing a configuration of a display device according to a comparative example. FIG. 14 illustrates a timing diagram showing clock signals and drive signals (scan signals and discharge control signals) of the comparative example. FIG. 15 illustrates a timing diagram showing clock signals and drive signals (light-emission control signals) of the comparative example. Here, clock signal lines Ka to Kf are supplied with clock signals CKa to CKf. GS1 and GS2 denote drive signals of respective scan signal lines G1 and G2, FS1 and FS2 denote drive signals of respective discharge control lines F1 and F2, and ES1 and ES2 denote drive signals of respective light-emission control lines E1 and E2.

In the comparative example, the signal waveforms (pulse waveforms) of the respective clock signals CKa to CKf are steep. Furthermore, the clock signals CKa and CKc are synchronous signals, and the clock signals CKb and CKd are synchronous signals. As a result, when a touch sensor is provided, noise is generated such that accuracy of the sensor is adversely affected by the noise.

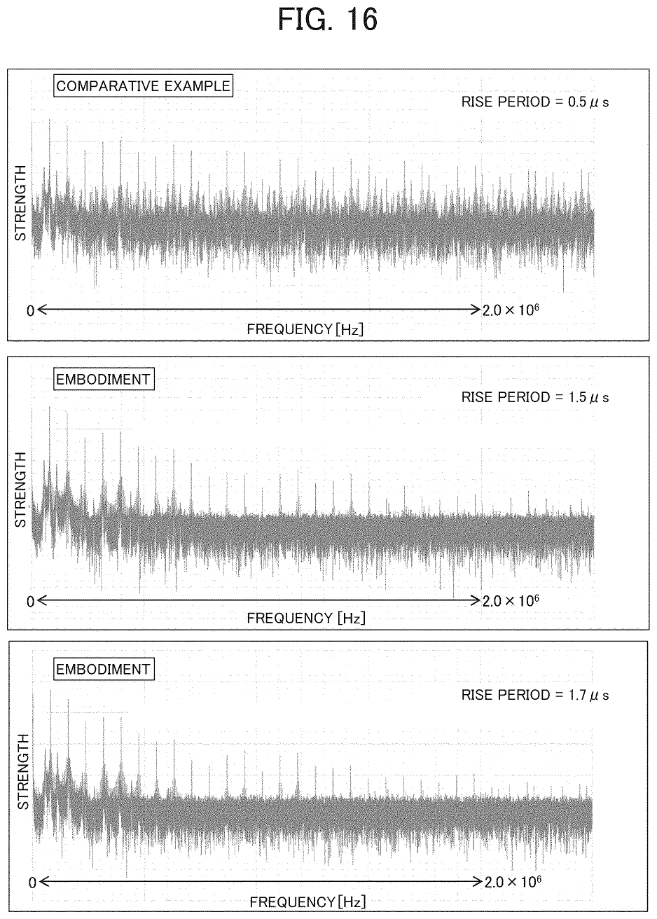

FIG. 16 illustrates graphs showing noise generated in the comparative example and the embodiment. The comparative example shows large noise in a band of 20 kHz to 2.0 MHz. Whereas the embodiment shows an effective reduction of the noise in a band of 20 kHz to 2.0 MHz. Note that FIG. 16 shows a case where the rise periods RT of the first clock signal CK1 to the sixth clock signal CK6 are set to 1.5 [μs] and 1.7 [μs].

The embodiment described above shows that, for at least one of a pair of the first clock signal CK1 and the second clock signal CK2, a pair of the third clock signal CK3 and the fourth clock signal CK4, or a pair of the fifth clock signal CK5 and the sixth clock signal CK6, the rise period RT and the fall period FT are set to 1.5 [μs] or longer so that noise reduction effects are obtained to provide the sensor with required accuracy. Specifically, a relationship of 1.5 [μsec]<a rise period (a fall period) of a pair of clock signals <an upper limit value of a drive protocol holds. Such a feature allows a degree of freedom in designing the touch sensor layer 16, thereby successfully reducing the size of the picture-frame unit of the display device provided with a touch sensor. The rise period (the fall period) of a pair of clock signals may be set to 15 to 35% of one horizontal scan period (1H).

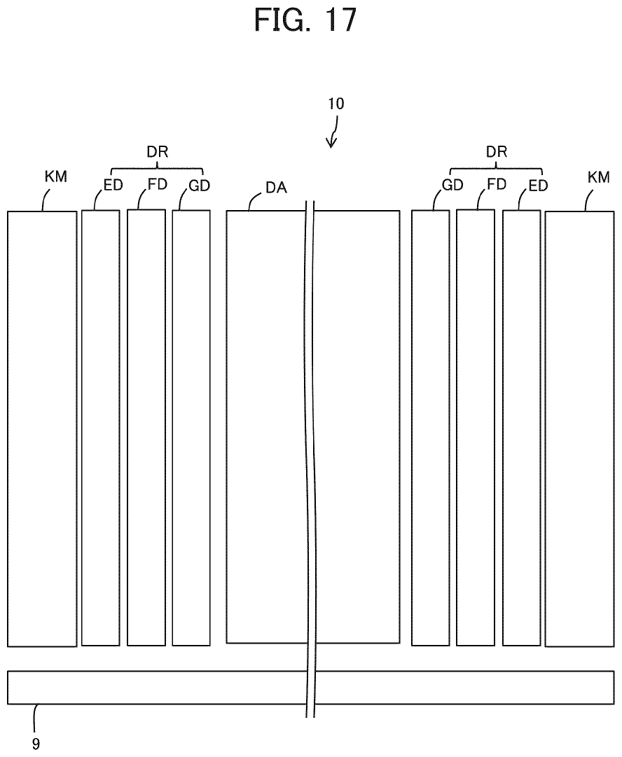

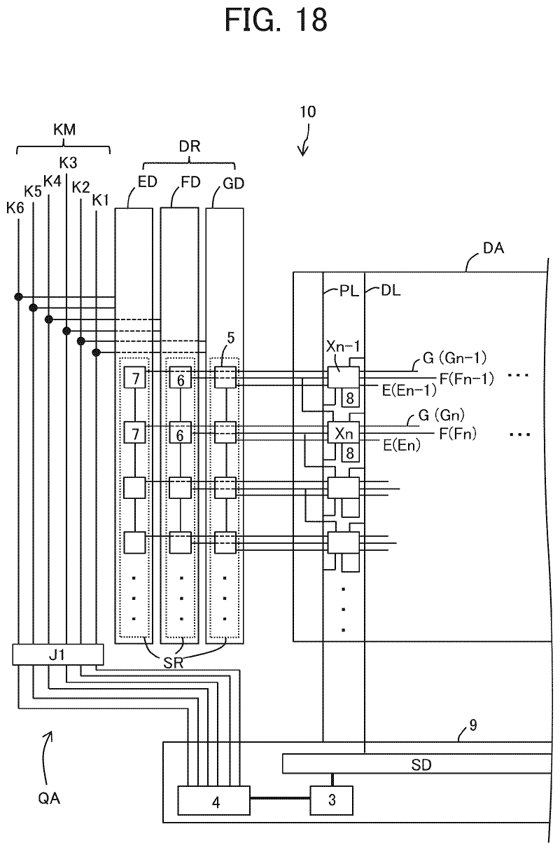

FIG. 17 illustrates a schematic diagram showing another configuration of the display device according to the embodiment. As illustrated in FIG. 17, clock signal line groups KM and driver circuits DR may be arranged on opposing sides of the display unit DA. FIG. 18 illustrates a schematic diagram showing another configuration of the display device according to the embodiment. As illustrated in FIG. 18, the first time-constant circuit J1 may be provided to a picture-frame unit QA (an outer edge of the display panel) positioned outside the display unit DA.

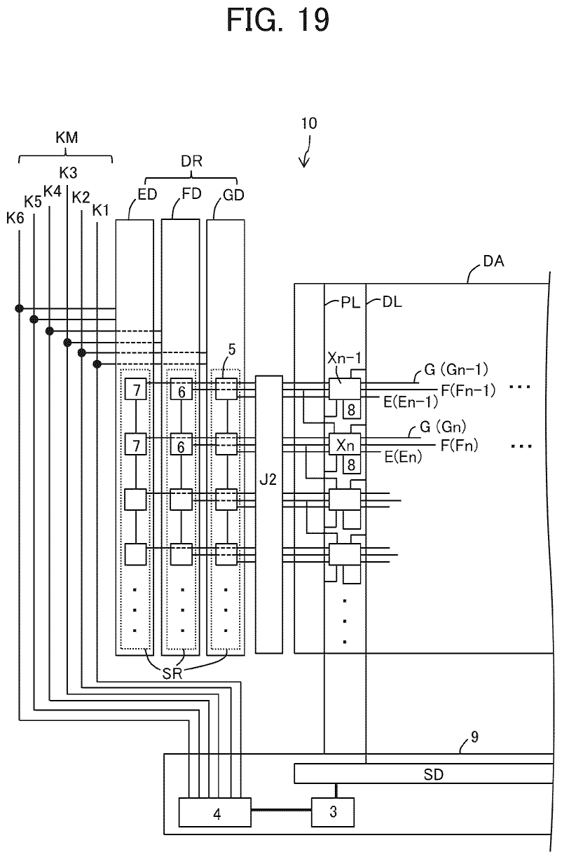

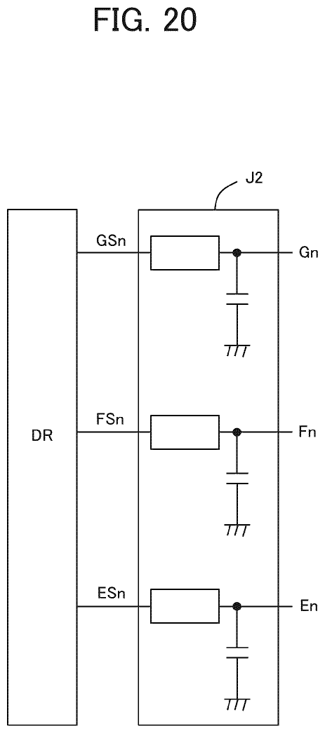

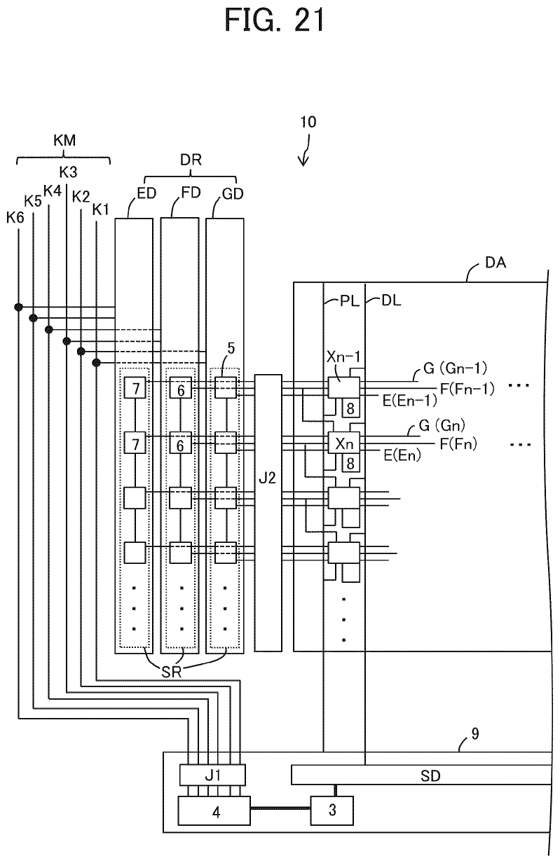

FIG. 19 illustrates a schematic diagram showing another configuration of the display device according to the embodiment. FIG. 20 illustrates an exemplary second time-constant circuit in FIG. 19. As illustrated in FIGS. 19 and 20, the display device 10 may be provided with a second time-constant circuit J2 connected between the driver circuit DR and the plurality of pixel circuits Xn-1 and Xn. As illustrated in FIG. 20, the second time-constant circuit J2 may distort a waveform of a drive signal to be input from the driver circuit DR. Here, the second time-constant circuit J2 may distort (see FIG. 20) a waveform of each of the scan signal GSn (a drive signal), the discharge control signal FSn (a drive signal), and the light-emission control signal ESn (a drive signal). Alternatively, the second time-constant circuit J2 may distort any given one or more of the waveforms. FIG. 21 illustrates a schematic diagram showing another configuration of the display device according to the embodiment. As illustrated in FIG. 21, the display device 10 may be provided with: the first time-constant circuit J1; and the second time-constant circuit J2.

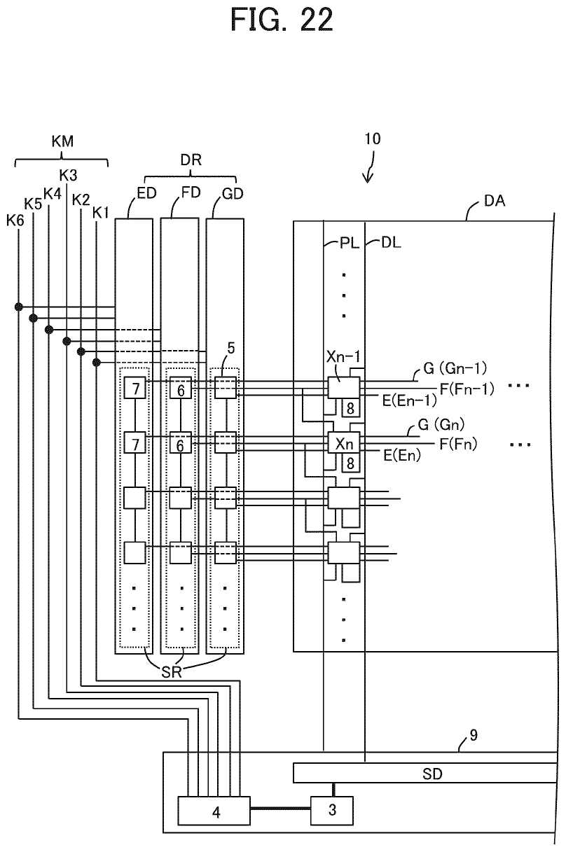

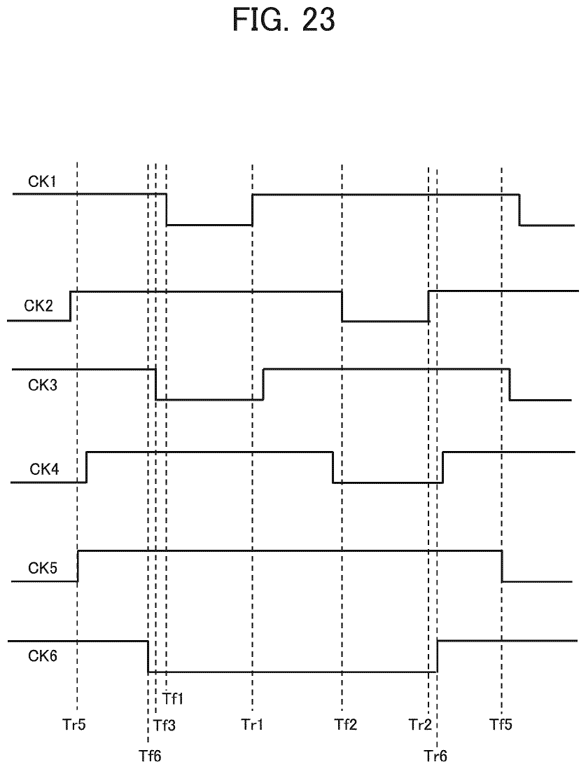

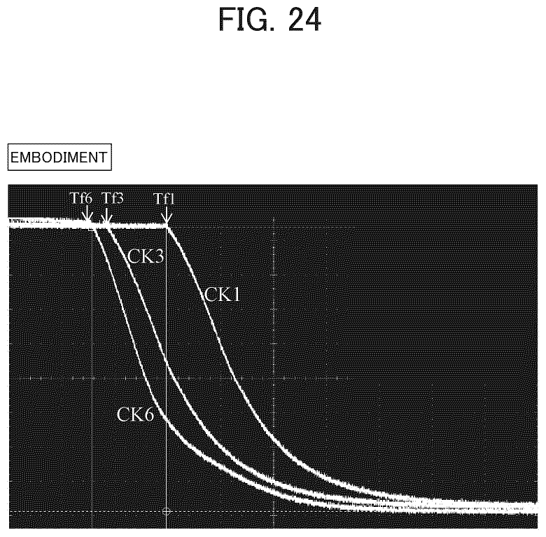

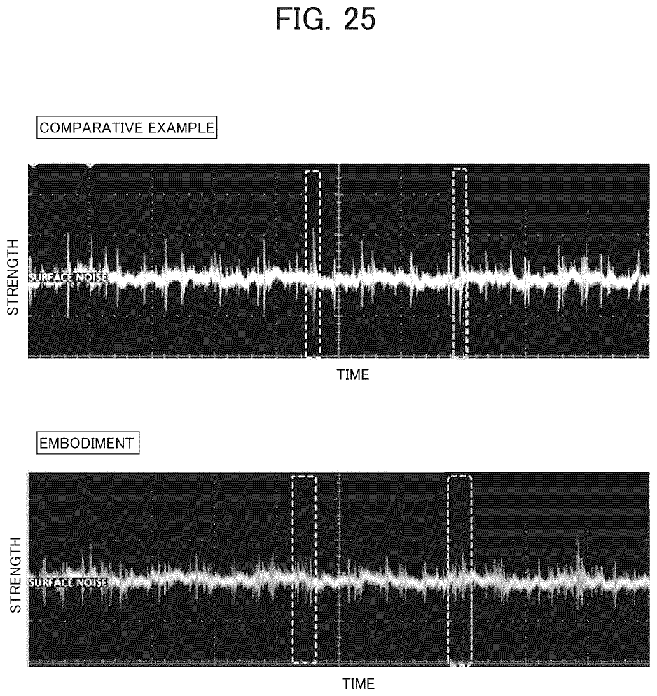

FIG. 22 illustrates a schematic diagram showing another configuration of the display device according to the embodiment. FIG. 23 illustrates a timing diagram showing clock signals according to another embodiment. FIG. 24 is a timing diagram showing a portion of FIG. 23 under magnification. FIG. 25 illustrates graphs showing a noise reducing effect according to the configuration in FIG. 23. As shown in FIGS. 23 and 24, a rise timing Tr1 of the first clock signal CK1 may be different from rise timings of the third clock signal CK3 and the fourth clock signal CK4. A fall timing Tf1 of the first clock signal CK1 may be different from fall timings of the third clock signal CK3 and the fourth clock signal CK4. Tf3 in FIGS. 23 and 24 denotes a fall timing of the third clock signal CK3. Furthermore, a rise timing Tr2 of the second clock signal CK2 may be different from rise timings of the third clock signal CK3 and the fourth clock signal CK4. A fall timing Tf2 of the second clock signal CK2 may be different from fall timings of the third clock signal CK3 and the fourth clock signal CK4.

Each of the rise timings and the fall timings may be a timing to start variations of a potential in association with formation of a pulse (see FIG. 24). Note that the rise timing may be a rise period, and the fall timing may be a fall period.

As can be seen, either the rise timing or the fall timing is shifted between the pair of the first clock signal CK1 and the second clock signal CK2 and the pair of the third clock signal CK3 and the fourth clock signal CK4. Such a feature achieves an advantageous effect of reducing noise as seen in FIG. 25. In this case, an active period (a Low period) of the third clock signal CK3 may include an active period (a Low period) of the first clock signal CK1. Furthermore, an active period (a Low period) of the fourth clock signal CK4 may include an active period (a Low period) of the second clock signal CK2. Thanks to such a feature, in a pixel X, data can be written during a discharge period from a data signal line DL.

In FIG. 23, a rise timing Tr5 of the fifth clock signal CK5 may be different from rise timings of the first clock signal CK1 to the fourth clock signal CK4. A fall timing Tf5 of the fifth clock signal CK5 may be different from fall timings of the first clock signal CK1 to the fourth clock signal CK4. In FIG. 23, a rise timing Tr6 of the sixth clock signal CK6 may be different from rise timings of the first clock signal CK1 to the fourth clock signal CK4. A fall timing Tf6 of the sixth clock signal CK6 may be different from fall timings of the first clock signal CK1 to the fourth clock signal CK4.

The waveforms of the first clock signal CK1 to the sixth clock signal CK6 in FIG. 23 can be distorted, using the configurations of, for example, FIGS. 1 and 10 (including the first time-constant circuit J1). See FIG. 12. Such a feature can further enhance the noise reduction effect.

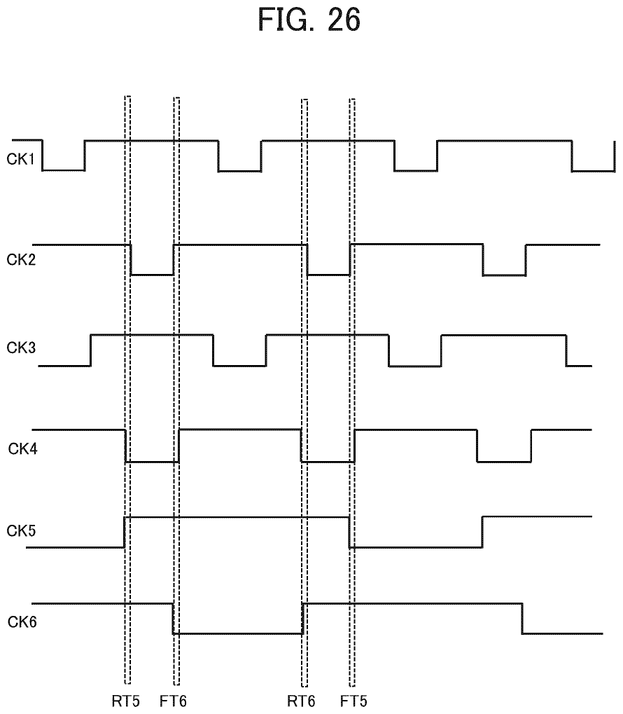

FIG. 26 illustrates a timing diagram showing clock signals according to another embodiment. As illustrated in FIG. 26, a rise period RT5 of the fifth clock signal CK5 may overlap with a fall period of at least one of the second clock signal CK2 or the fourth clock signal CK4. The rise period RT5 of the fifth clock signal CK5 may overlap also with fall periods of the second clock signal CK2 and the fourth clock signal CK4.

A fall period FT5 of the fifth clock signal CK5 may overlap with a rise period of at least one of the second clock signal CK2 or the fourth clock signal CK4. The fall period FT5 of the fifth clock signal CK5 may overlap also with rise periods of the second clock signal CK2 and the fourth clock signal CK4.

As can be seen, potential variations in association with formation of a pulse of the fifth clock signal CK5 and potential variations in association with formation of pulses of the second clock signal CK2 and the fourth clock signal CK4 are set in the same period in opposite directions. Such a feature achieves an advantageous effect of reducing noise.

A rise period RT6 of the sixth clock signal CK6 may overlap with the fall period of at least one of the second clock signal CK2 or the fourth clock signal CK4. The rise period RT6 of the sixth clock signal CK6 may overlap also with fall periods of the second clock signal CK2 and the fourth clock signal CK4.

A fall period FT6 of the sixth clock signal CK6 may overlap with a rise period of at least one of the second clock signal CK2 or the fourth clock signal CK4. The fall period FT6 of the sixth clock signal CK6 may overlap also with rise periods of the second clock signal CK2 and the fourth clock signal CK4.

As can be seen, potential variations in association with formation of a pulse of the sixth clock signal CK6 and potential variations in association with formation of pulses of the second clock signal CK2 and the fourth clock signal CK4 are set in the same period in opposite directions. Such a feature achieves an advantageous effect of reducing noise.

Each of the above-described embodiments is presented not for limitative purposes but for illustrative and descriptive purposes. It will be apparent to those skilled in the art that many variations are applicable in accordance with these illustrations and descriptions.

1: A display device, comprising:
a clock signal output circuit:
a plurality of clock signal lines;
a driver circuit including a shift register and electrically connected to the plurality of clock signal lines;
a plurality of pixel circuits;
at least one of a first time-constant circuit connected between the clock signal output circuit and the plurality of clock signal lines or a second time-constant circuit connected between the driver circuit and the plurality of pixel circuits; and
a touch sensor layer including: a sensor electrode group; and a routed wire group electrically connected to the sensor electrode group,
wherein the touch sensor layer includes a routing region in which the routed wire group is formed, and
in a plan view, the routing region overlaps with the plurality of clock signal lines.

2. (canceled)

3: The display device according to claim 1,
wherein the first time-constant circuit distorts waveforms of a plurality of clock signals to be input from the clock signal output circuit.

4: The display device according to claim 1,
wherein the second time-constant circuit distorts a waveform of a drive signal to be input from the driver circuit.

5: The display device according to claim 1, further comprising
a plurality of scan signal lines,
wherein the driver circuit outputs a drive signal to each of the plurality of scan signal lines.

6-7. (canceled)

8: The display device according to claim 1,
wherein each of the plurality of clock signal lines is supplied with a clock signal, and
each of a rise period and a fall period of the clock signal is 1.5 [μs] or longer.

9: The display device according to claim 1,
wherein each of the plurality of clock signal lines is supplied with a clock signal, and
each of a rise period and a fall period of the clock signal is set to 15[%] to 35[%] of one horizontal scanning period.

10: A display device, comprising:
a first driver configured to receive a first clock signal and a second clock signal and to generate a scan signal, a second driver configured to receive a third clock signal and a fourth clock signal and to generate a discharge control signal, and a pixel circuit configured to receive the scan signal and the discharge control signal,
wherein a rise timing of the first clock signal is different from rise timings of the third clock signal and the fourth clock signal.

11. The display device according to claim 10,
wherein
a fall timing of the first clock signal is different from fall timings of the third clock signal and the fourth clock signal.

12: The display device according to claim 10,
wherein a rise timing of the second clock signal is different from rise timings of the third clock signal and the fourth clock signal.

13: The display device according to claim 10,
wherein a fall timing of the second clock signal is different from fall timings of the third clock signal and the fourth clock signal.

14: The display device according to claim 10, of claims 10 to 13,
wherein an active period of the third clock signal includes an active period of the first clock signal.

15: The display device according to claim 10,
wherein an active period of the fourth clock signal includes an active period of the second clock signal.

16: The display device according to claim 10, further comprising
a third driver configured to receive a fifth clock signal and a sixth clock signal and to generate a light-emission control signal,
wherein the pixel circuit receives the light-emission control signal, and
a rise timing of the fifth clock signal is different from rise timings of the first clock signal to the fourth clock signal.

17: The display device according to claim 16,
wherein a fall timing of the fifth clock signal is different from fall timings of the first clock signal to the fourth clock signal.

18-19. (canceled)

20: A display device, comprising:
a first driver configured to receive a first clock signal and a second clock signal and to generate a scan signal; a second driver configured to receive a third clock signal and a fourth clock signal and to generate a discharge control signal; a third driver configured to receive a fifth clock signal and a sixth clock signal and to generate a light-emission control signal; and a pixel circuit configured to receive the scan signal, the discharge control signal, and the light-emission control signal,
wherein a rise period of the fifth clock signal overlaps with a fall period of at least one of the second clock signal or the fourth clock signal.

21: The display device according to claim 20,
wherein the rise period of the fifth clock signal overlaps with fall periods of the second clock signal and the fourth clock signal.

22: The display device according to claim 20,
wherein a fall period of the fifth clock signal overlaps with a rise period of at least one of the second clock signal or the fourth clock signal.

23. (canceled)

24: The display device according to claim 20,
wherein a rise period of the sixth clock signal overlaps with the fall period of at least one of the second clock signal or the fourth clock signal.

25. (canceled)

26: The display device according to claim 20,
wherein a fall period of the sixth clock signal overlaps with a rise period of at least one of the second clock signal or the fourth clock signal.

27. (canceled)

28: The display device according to claim 10, further comprising:
a touch sensor layer including a sensor electrode group and a routed wire group electrically connected to the sensor electrode group; a first clock signal line that transmits the first clock signal; and a second clock signal line that transmits the second clock signal,
wherein the touch sensor layer includes a routing region in which the routed wire group is formed, and
in a plan view, the routing region overlaps with the first clock signal line and the second clock signal line.

29-31. (canceled)
